(19) United States
(12) Patent Application Publication
(10) Pub. No.: US 2016/0060801 A1
(43) Pub. Date: Mar. 3, 2016

(54) METHOD OF BRAKING A ROTATING DRUM

(71) Applicant: Whirlpool Corporation, Benton Harbor, MI (US)

(72) Inventors: MICHAEL L. JACKEMEYER, BUCHANAN, MI (US); GUILHERME MARTINHON, RIO CLARO (BR); TIAGO A. MELITO, RIO CLARO (BR); DANIEL P. PEREIRA, RIO CLARO (BR); MARK B. SAWYER, SAINT JOSEPH, MI (US); PAUL F. SPINDLER, ZEELAND, MI (US)

(73) Assignee: WHIRLPOOL CORPORATION, Benton Harbor, MI (US)

(21) Appl. No.: 14/468,407

(22) Filed: Aug. 26, 2014

(51) Int. Cl. D06F 37/42; D06F 37/30; H02P 3/18; D06F 33/02

(52) U.S. Cl. CPC D06F 37/42; D06F 33/02; D06F 37/304; H02P 3/18; D06F 2202/065; D06F 2204/065

(57) ABSTRACT

A method of braking a rotating drum in a laundry treating apparatus having a rotating drum rotatably driven by a single-phase permanent split capacitor (PSC) motor includes energizing a first winding of the PSC motor to apply a first rotational force to the drum to effect a rotation of the drum in a first direction and energizing a second winding of the PSC motor to apply a braking force.

### BACKGROUND OF THE INVENTION

Laundry treating appliances, such as a washing machine, may implement cycles of operation in which a drum defining a treating chamber for receiving a laundry load is rotated at high speeds, such as a spin or water extraction phase. For example, to extract the water from the laundry load, the drum is typically spun at high speeds. For certain cycles of operation, the cycle may not be completed until rotation of the drum has ceased.

### SUMMARY OF THE INVENTION

In one aspect, a method of braking a rotating drum in a laundry treating apparatus having a rotating drum rotatably driven by a single-phase, permanent split capacitor (PSC) motor, includes energizing a first winding of the PSC motor to apply a first rotational force to the drum to effect a rotation of the drum in a first direction, and energizing a second winding, wound opposite of the first winding, of the PSC motor to apply a second rotational force to the drum, opposite the first rotational force, to slow the rotational speed of the drum in the first direction.

### BRIEF DESCRIPTION OF THE DRAWINGS IN THE DRAWINGS

FIG. 1 is a schematic view of a laundry treating appliance in the form of a horizontal axis washing machine, in accordance with an embodiment of the invention.

FIG. 2 is a schematic of a control system of the laundry treating appliance of FIG. 1 according to an embodiment of the invention.

FIG. 3 is a flowchart view of one embodiment of the invention.

FIG. 4 is a graph illustrating the reduction of braking time of the rotating drum, in accordance with one embodiment of the invention.

FIG. 5 is a schematic view of a laundry treating appliance in the form of a vertical axis washing machine, in accordance with another embodiment of the invention.

### DESCRIPTION OF EMBODIMENTS OF THE INVENTION

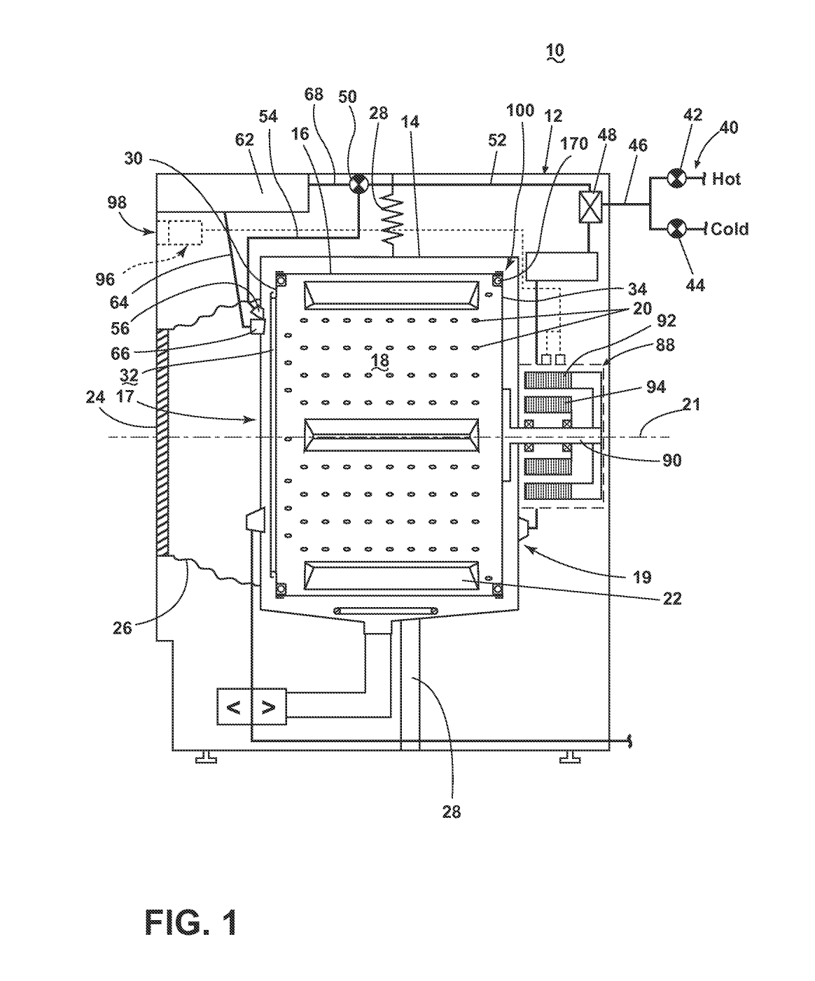

FIG. 1 is a schematic view of a laundry treating appliance according to a first embodiment of the invention. The laundry treating appliance may be any appliance which performs a cycle of operation to clean or otherwise treat items placed therein, non-limiting examples of which include a horizontal or vertical axis clothes washer; a combination washing machine and dryer; a tumbling or stationary refreshing/revitalizing machine; an extractor; a non-aqueous washing apparatus; and a revitalizing machine.

The laundry treating appliance of FIG. 1 is illustrated as a washing machine 10, which may include a structural support system comprising a cabinet 12 which defines a housing within which a laundry holding system resides. The cabinet 12 may be a housing having a chassis and/or a frame, defining an interior that encloses components typically found in a conventional washing machine, such as motors, pumps, fluid lines, controls, sensors, transducers, and the like. Such components will not be described further herein except as necessary for a complete understanding of embodiments of the invention.

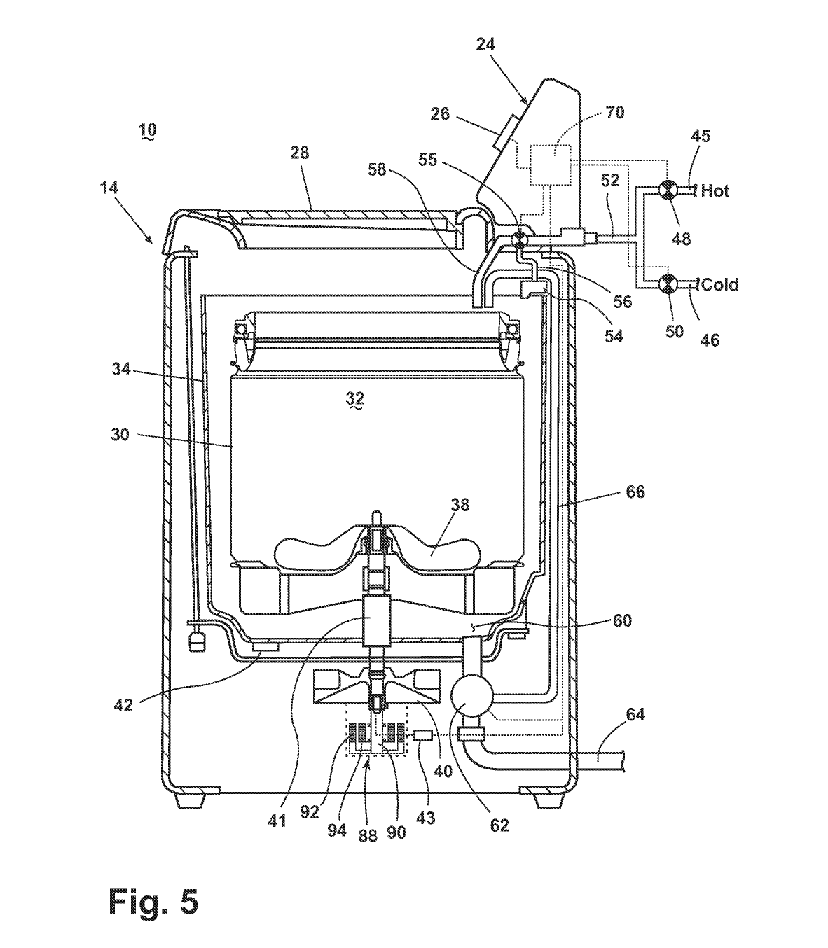

The laundry holding system comprises a tub 14 supported within the cabinet 12 by a suitable suspension system and a rotatable drum 16 provided within the tub 14, the rotatable drum 16 defining at least a portion of a laundry treating chamber 18 having a longitudinal axis 21. The longitudinal axis 21 of the rotatable drum 16 is preferably coincident with a horizontal or non-vertical axis of rotation of the drum 16, though it is within the scope of the invention to accommodate a rotatable drum on a vertical axis of rotation. See, for example, an embodiment of a vertical axis washing machine according to another embodiment of the invention in FIG. 5. The rotatable drum 16 may include a plurality of perforations 20 such that liquid may flow between the tub 14 and the rotatable drum 16 through the perforations 20. A plurality of baffles 22 may be disposed on an inner surface of the rotatable drum 16 to lift the laundry load received in the treating chamber 18 while the rotatable drum 16 rotates. It is also within the scope of the invention for the laundry holding system to comprise only a tub with the tub defining the laundry treating chamber.

The rotatable drum 16 has a front side 17 and a rear side 19, respectively, at each end. The front side 17 includes a front cover 30 with an opening 32 therein to accommodate receiving a laundry load. The rear side 19 also has a rear cover 34. The covers 30, 34 thus form part of the drum 16.

The laundry holding system may further include a door 24 which may be movably mounted to the cabinet 12 to selectively close both the tub 14 and the drum 16. A bellows 26 may couple an open face of the tub 14 with the cabinet 12, with the door 24 sealing against the bellows 26 when the door 24 closes the tub 14.

The washing machine 10 may further include a suspension system 28 for dynamically suspending the laundry holding system within the structural support system.

The washing machine 10 may further include a liquid supply system for supplying water to the washing machine 10 for use in treating laundry during a cycle of operation. The liquid supply system may include a source of water, such as a household water supply 40, which may include separate valves 42 and 44 for controlling the flow of hot and cold water, respectively. Water may be supplied through an inlet conduit 46 directly to the tub 14 by controlling first and second diverter mechanisms 48 and 50, respectively. The diverter mechanisms 48, 50 may be a diverter valve having two outlets such that the diverter mechanisms 48, 50 may selectively direct a flow of liquid to one or both of two flow paths. Water from the household water supply 40 may flow through the inlet conduit 46 to the first diverter mechanism 48 which may direct the flow of liquid to a supply conduit 52. The second diverter mechanism 50 on the supply conduit 52 may direct the flow of liquid to a tub outlet conduit 54 which may be provided with a spray nozzle 56 configured to spray the flow of liquid into the tub 14. In this manner, water from the household water supply 40 may be supplied directly to the tub 14.

The washing machine 10 may also be provided with a dispensing system for dispensing treating chemistry to the treating chamber 18 for use in treating the laundry according to a cycle of operation. The dispenser 62 may be configured to dispense a treating chemistry directly to the tub 14 or mixed with water from the liquid supply system through a dispensing outlet conduit 64. The dispensing outlet conduit 64 may include a dispensing nozzle 66 configured to dispense the treating chemistry into the tub 14 in a desired pattern and under a desired amount of pressure. For example, the dispensing nozzle 66 may be configured to dispense a flow or stream of treating chemistry into the tub 14 by gravity, i.e. a non-pressurized stream. Water may be supplied to the dispenser 62 from the supply conduit 52 by directing the diverter mechanism 50 to direct the flow of water to a dispensing supply conduit 68.

Non-limiting examples of treating chemistries that may be dispensed by the dispensing system during a cycle of operation include one or more of the following: water, enzymes, fragrances, stiffness/sizing agents, wrinkle releasers/reducers, softeners, antistatic or electrostatic agents, stain repellants, water repellants, energy reduction/extraction aids, antibacterial agents, medicinal agents, vitamins, moisturizers, shrinkage inhibitors, and color fidelity agents, and combinations thereof.

The washing machine 10 may further comprise additional and/or alternative liquid supply, recirculation, and drain systems which are not germane to embodiments of the invention. Examples of additional and/or alternative liquid supply, recirculation, and drain systems may include valves, conduits, treating chemistry dispensers, sensors, such as water level sensors and temperature sensors, and the like, to control the flow of liquid through the washing machine 10 and for the introduction of more than one type of treating chemistry.

The washing machine 10 also includes a drive system for rotating the drum 16 within the tub 14. The drive system may include a motor 88, which may be directly coupled with the rotatable drum 16 through a drive shaft 90 at or about the rear cover 34 to rotate the drum 16 about a rotational axis during a cycle of operation. Alternately, the motor 88 may be coupled to the drum 16 through a belt and a drive shaft to rotate the rotatable drum 16, as is known in the art.

The motor 88 may be a single-phase permanent split capacitor (PSC) motor 88 having a first set of windings 92 wound in a first direction and a second set of windings 94 wound opposite of the first windings 92. As used herein, the second set of windings 94 wound “opposite” of the first windings 92 may be defined by the first and second windings 92, 94 having a phase difference between the windings 92, 94, which, for example, may be configured by the capacitor of the PSC motor 88. As used, the phase difference between the first windings 92 and second windings 94 may provide torque or rotational force in different rotational directions, depending on which of the first or second windings 92, 94 are energized. Non-limiting examples of oppositely wound windings 92, 94 may include the dual windings 92, 94 alternatingly located along a common stator of the motor 88, or interleaved stators, wherein each stator includes one of the respective windings 92, 94.

The PSC motor 88 is configured such that energizing the first windings 92 with an energy source, such as an AC wall outlet, applies a first rotational force, or torque, to the drum 16 to effect a rotation of the drum 16 in a first direction, such as clockwise. Additionally, the PSC motor 88 is configured such that energizing the second windings 94 with an energy source, such as an AC wall outlet, applies a second rotational force, or torque, to the drum 16 in an opposite direction of the first rotational force, to effect a rotation of the drum 16 in a second direction, such as counter-clockwise. Other motors having dual windings, as described herein, may also be used. The motor 88 may rotate the drum 16 at various speeds in either rotational direction.

The washing machine 10 also includes a control system for controlling the operation of the washing machine 10 to implement one or more cycles of operation. The control system may include a controller 96 located within the cabinet 12 and a user interface 98 that is operably coupled with the controller 96. The user interface 98 may include one or more knobs, dials, switches, displays, touch screens and the like for communicating with the user, such as to receive input and provide output. The user may enter different types of information including, without limitation, cycle selection and cycle parameters, such as cycle options.

The controller 96 may include the machine controller and any additional controllers provided for controlling any of the components of the washing machine 10. For example, the controller 96 may include the machine controller and a motor controller. Many known types of controllers may be used for the controller 96. The specific type of controller is not germane to embodiments of the invention. It is contemplated that the controller is a microprocessor-based controller that implements control software and sends/receives one or more electrical signals to/from each of the various working components to effect the control software. As an example, proportional control (P), proportional integral control (PI), and proportional derivative control (PD), or a combination thereof, a proportional integral derivative control (PID control), may be used to control the various components.

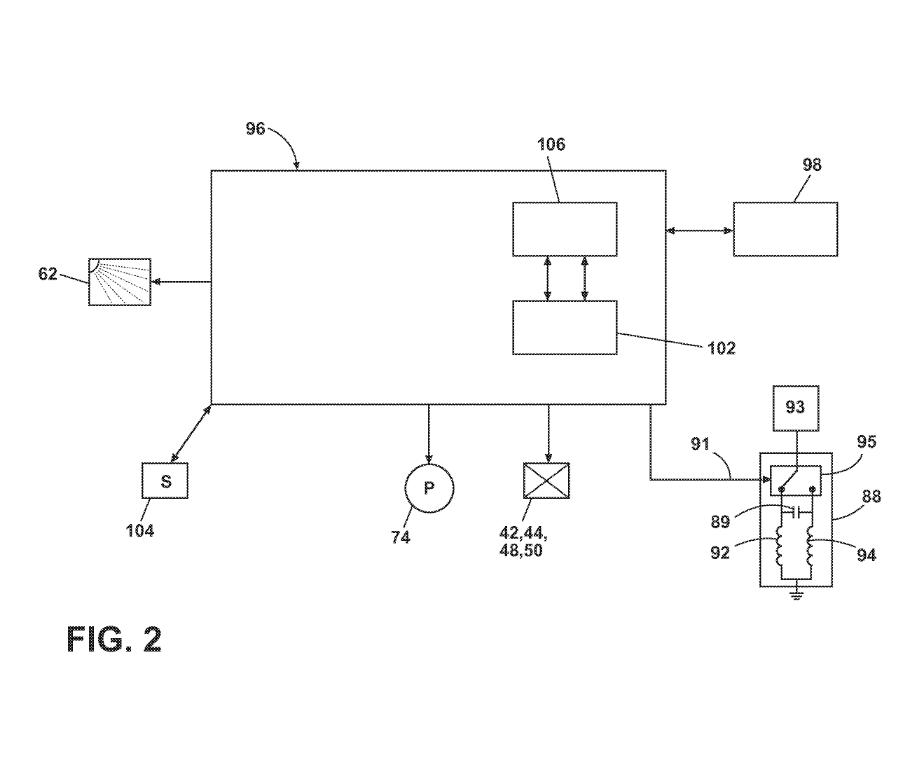

As illustrated in FIG. 2, the controller 96 may be provided with a memory 106 and a central processing unit (CPU) 102. The memory 106 may be used for storing the control software that is executed by the CPU 102 in completing a cycle of operation using the washing machine 10 and any additional software. Examples, without limitation, of cycles of operation include: wash, heavy duty wash, delicate wash, quick wash, pre-wash, refresh, rinse only, and timed wash. The memory 106 may also be used to store information, such as a database or table, and to store data received from one or more components of the washing machine 10 that may be communicably coupled with the controller 96. The database or table may be used to store the various operating parameters for the one or more cycles of operation, including factory default values for the operating parameters and any adjustments to them by the control system or by user input.

The controller 96 may be operably coupled with one or more components of the washing machine 10 for communicating with and controlling the operation of the component to complete a cycle of operation. For example, the controller 96 may be operatively coupled with the PSC motor 88, such that it may provide a control signal 91 to supply energy from an energy source 93 to energize the first or second windings 92, 94 to implement one or more cycles of operation.

As illustrated, the PSC motor 88 may include a switching component 95 which operates in response to the control signal 91 to energize the first or second windings 92, 94. For example, as used herein and shown, an “energizing of the first windings 92” energizes the first windings 92 directly, and may also energize the second windings 94, configured in parallel, and downstream from the phase difference capacitor 89 to effect a rotational force of the drum 16 in a first direction. Conversely, as used herein, an “energizing of the second windings 94” energizes the second windings 94 directly, and may also energize the first windings 92, configured in parallel, and downstream from the phase difference capacitor 89 to effect a rotational force of the drum 16 in a second direction, opposite the first direction.

Alternative application of energizing controls may be included to control which of the first or second windings 92, 94 may be energized. For example, the switching component 95 may be located remotely from the PSC motor 88, or the controller 96 may provide one or more additional control signals 91 related to operation of each respective first or second windings 92, 94. The controller 96 may be operably coupled with additional components, for example, the dispenser 62, to control the operation of these and other components to implement one or more of the cycles of operation.

The controller 96 may also be coupled with one or more sensors 104 provided in one or more of the systems of the washing machine 10 to receive input from the sensors, which are known in the art and not shown for simplicity. Non-limiting examples of sensors 104 that may be communicably coupled with the controller 96 include: a treating chamber temperature sensor, a moisture sensor, a weight sensor, a chemical sensor, a position sensor, a motor rotational speed sensor or a drum rotational speed sensor, such as a tachometer, and a motor torque sensor, which may be used to determine a variety of system and laundry characteristics, such as laundry load inertia or mass.

During a cycle of operation, for example, during a water extraction phase, the controller 96 may control the PSC motor 88 to rotate the drum 16 at a high speed, for example, in a clockwise direction. One example of an extraction phase may include drum 16 rotational speeds greater than 250 rotations per minute (RPM). In the prior art, when a rotation cycle of operation ceases, or when a water extraction phase is completed, or when the rotation of the drum 16 in a first direction reaches a predetermined speed (for instance, as measured by the tachometer), or in response to a “stop” or “braking” command issued at the user interface 98, the controller 96 typically responds by ceasing the energizing of the respective first or second windings 92, 94 that have been applying the rotational force. The ceasing of the application of rotational force by the PSC motor 88 may allow the rotating drum 16 to reduce rotational speeds due to friction, or by “free coasting”, that is, by coasting the rotation without external influence or interference, until the drum 16 ceases rotation altogether.

Embodiments of the invention include a method of braking a rotating drum 16, wherein the method energizes the first winding 92 of the PSC motor 88 to apply a first rotational force to the drum 16 to effect a rotation of the drum 16 in a first direction, and then energizing the second winding 94 of the PSC motor 88 to apply a second rotational force to the drum 16, opposite the first rotational force, to slow the rotational speed of the drum 16 in the first direction. In the above-described example, wherein a rotation cycle of operation is stopped, for example, when a water extraction phase is completed, or in response to a “stop” or “braking” command issued at the user interface 98, the controller 96 responds by providing a control signal 91 to toggle the switching component 95 ceasing the energizing of the first windings 92, and energizing the second windings 94, which generates an opposite torque to slow the rotation of the drum 16 at a faster rate than if the drum 16 were allowed to free coast to a stop. The toggle of the switching component 95 may provide for a simultaneous ceasing of the energizing of the first windings 92 and energizing of the second windings 94, or may cease the energizing of the first windings 92 prior to the energizing of the second windings 94. The switching component 95 may be configured so that first and second windings 92, 94 are never energized simultaneously.

The application of the method of braking the rotating drum 16 may further include implementation of one or more braking algorithms or control steps, as applied by the controller 96. For example, the memory 106 of the controller 96 may include one or more predetermined rotational speed thresholds for use in controlling the braking method. In this example, the controller 96 may include a first RPM threshold with a maximum speed at which the braking method is enabled, or high-speed threshold value, and a second RPM threshold with a minimum speed, or low-speed threshold value, between which the braking method is enabled.

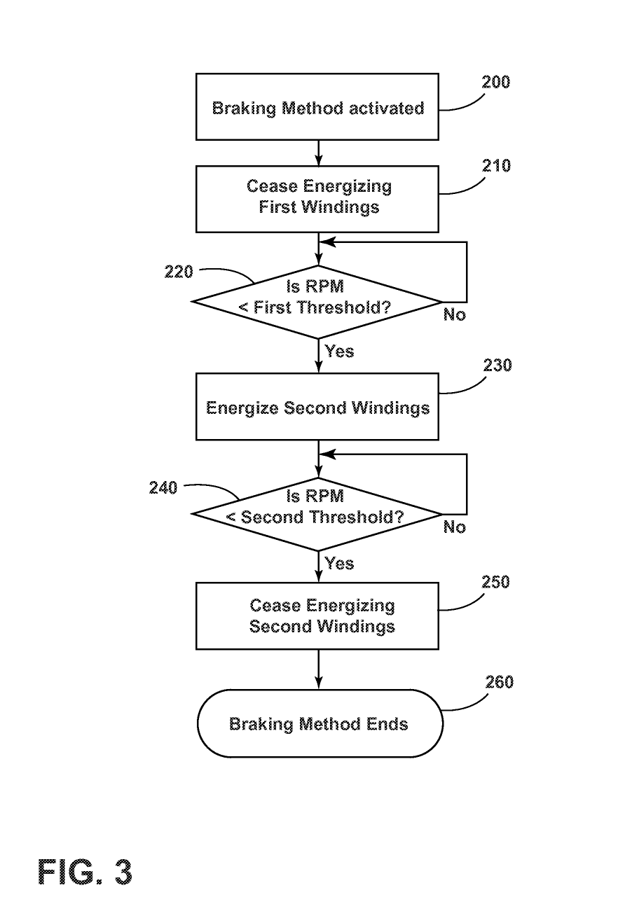

One embodiment of the invention is illustrated in FIG. 3. In step 200, a “stop” or “brake” command is issued by the controller 96, in response to, for example, the completion of a cycle of operation, such as a spin cycle, or in response to a stop command originated by the user interface 98. Then, in step 210, the controller 96 ceases energizing the first windings 92. Next, in step 220, the controller 96 may provide a first comparison of the current speed of the rotating drum 16, as measured, for instance, by the tachometer, to the first RPM threshold. If the rotating drum 16 is spinning at an RPM greater than the first RPM threshold, the braking method may allow the drum to free coast for a period of time, and operate the first comparison again, or the braking method may continuously provide the first comparison until the current speed of the drum 16 is less than the first RPM threshold. Upon satisfaction of the first comparison, in step 230, the controller 96 may provide a control signal 91 to energize the second windings 94. In step 240, the braking method may then continue to operate such that it may provide a second comparison of the current speed of the rotating drum 16 with the second RPM threshold value. Upon satisfaction of the second comparison, in step 250, the controller 96 may cease the energizing of the second windings 94. The braking method then ends in step 260.

Examples of first RPM threshold may include 250 RPMs, 200 RPMs, 150 RPMs, etc., and may be predetermined based on the expected and/or desired rate of braking for the washing machine 10, for instance, as designed per cycle of operation, per drum 16 size, shape, and/or configuration, and/or laundry load characteristics (e.g. load inertial, load balance, etc.). Examples of the second RPM threshold may include zero RPMs (i.e. the ceasing the energizing of the second windings 94 occurs when the rotation ceases), or it may include a non-zero RPM value, such as 15 RPMs. In the example where the second RPM threshold includes a non-zero RPM value, the rotating drum 16 may be allowed to free coast to a stop. Again, the second RPM threshold may be predetermined base on similar design considerations as those mentioned for the first RPM threshold.

The term “satisfies” the threshold is used herein to mean that the comparisons satisfy the respective predetermined thresholds, such as being equal to or less than the respective threshold value. It will be understood that such a determination may easily be altered to be satisfied by a positive/negative comparison or a true/false comparison.

The application of the method of braking the rotating drum 16 may yet further include energizing the respective first or second windings 92, 94 with altered or unaltered power from the energy source 93. For example, each of the energizing the first and second windings 92, 94 may further include providing a single-phase AC power to the respective windings 92, 94. Alternatively, one or both of the energizing of the first and/or second windings 92, 94 may include altering single-phase AC power to, for example, produce a predetermined duty cycle or pulsed energizing of the second windings 94, according an algorithm, to provide for a more rapid or slower braking method, as compared to an unaltered single-phase AC power. In this alternative example, the algorithm may be stored in the memory 106, and control the energizing of the second windings 94 by the controller 96 and/or control signal 91. In yet another embodiment of the invention, the energizing of the second windings 94 may further include providing altered power to the second windings 94, such as half-wave or full-wave rectified power. Embodiments of the invention may further include application of a plurality of altered or unaltered energizing to the respective first and/or second windings 92, 94.

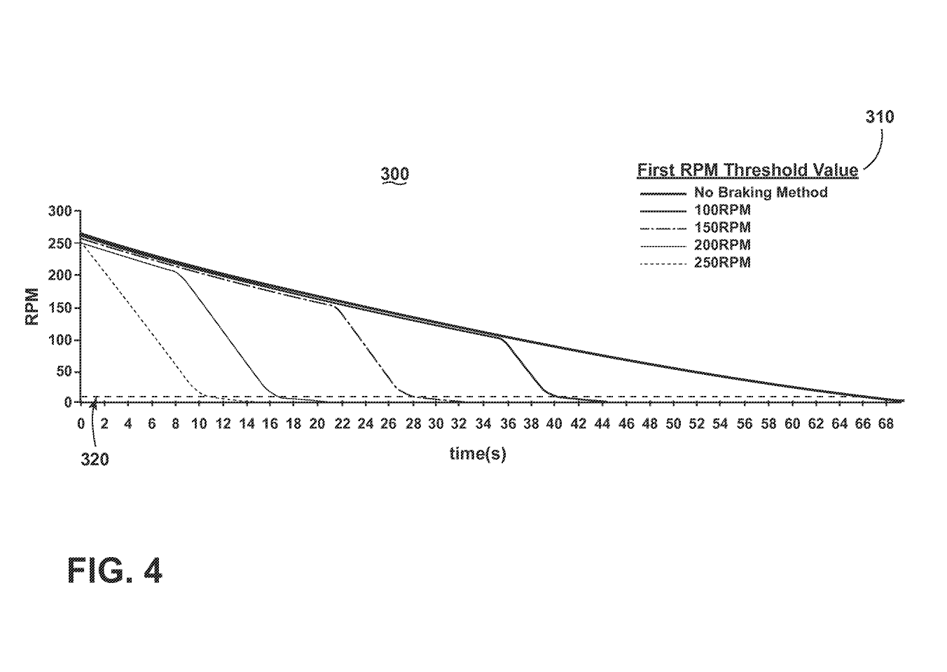

FIG. 4 is a graph 300 that illustrates the application of the braking method described herein, as applied to a test laundry load in a rotating drum 16. The graph 300 demonstrates the reduction of spin time for a test drum 16, according to various first RPM threshold values 310, and a non-varying second RPM threshold value 320. In one example, the braking method reduces the spin time from 69 seconds to 14 seconds.

To the extent not already described, the different features and structures of the various embodiments may be used in combination with each other as desired. That one feature may not be illustrated in all of the embodiments is not meant to be construed that it cannot be, but is done for brevity of description. Thus, the various features of the different embodiments may be mixed and matched as desired to form new embodiments, whether or not the new embodiments are expressly disclosed.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A method of braking a rotating drum in a laundry treating apparatus having a rotating drum rotatably driven by a single-phase, permanent split capacitor (PSC) motor, the method comprises:
energizing a first winding of the PSC motor to apply a first rotational force to the drum to effect a rotation of the drum in a first direction; and
energizing a second winding, wound opposite of the first winding, of the PSC motor to apply a second rotational force to the drum, opposite the first rotational force, to slow the rotation of the drum in the first direction.

2. The method of claim 1 further comprising ceasing the energizing of the first winding prior to energizing the second winding.

3. The method of claim 1 wherein the energizing the first winding effects a rotation of the drum in the first direction to a first predetermined speed.

4. The method of claim 3 further comprising a first comparing of the first predetermined speed of the drum with a high-speed threshold value and energizing the second winding upon satisfaction of the first comparison.

5. The method of claim 4 further comprising a second comparing of rotational speed of the drum with a low-speed threshold value, and ceasing the energizing of the second winding upon satisfaction of the second comparison.

6. The method of claim 5 wherein energizing the second winding slows the rotational speed of the drum at a faster rate than if the drum were allowed to slow by coasting.

7. The method of claim 5 further comprising allowing the rotating drum to coast to a stop after ceasing the energizing of the second winding.

8. The method of claim 1 further comprising receiving a braking command from a controller prior to energizing the second winding.

9. The method of claim 1 further comprising receiving a braking command from a user interface prior to energizing the second winding.

10. The method of claim 1 wherein at least one of the energizing of the first winding or the energizing of the second winding further comprises providing a single-phase AC power to the respective first or second winding.

11. The method of claim 10 wherein the providing the single-phase AC power further comprises altering the single-phase AC power, prior to the providing, according to an algorithm.

12. The method of claim 11 wherein at least one of the energizing of the first winding or the energizing of the second winding further comprises providing a plurality of altered single-phase AC powers to the respective first or second winding.

13. The method of claim 1 wherein at least one of the energizing of the first winding or the energizing of the second winding further comprises providing half-wave rectified power to the respective first or second winding.
